(19) United States
(12) Patent Application Publication
(10) Pub. No.: US 2009/0325549 A1
(43) Pub. Date: Dec. 31, 2009

(54) OUT-OF-NETWORK WARNING SYSTEM AND METHOD FOR A MOBILE PHONE

(75) Inventor: CHIA-YUAN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/417,655

(22) Filed: Apr. 3, 2009

(30) Foreign Application Priority Data
Jun. 27, 2008 (CN) 200810302392.1

(51) Int. Cl. H04M 3/42

(52) U.S. Cl. 455/414.1

(57) ABSTRACT

An out-of-network warning method for a mobile phone is provided. The method establishes a communication network connection between the mobile phone and a TSP server while initiating a call from the mobile phone using a dialed phone number. The method uploads the dialed phone number to the TSP server to get a call type. The method displays the call type on the mobile phone for further action.

### BACKGROUND

1. Technical Field

Embodiments of the present disclosure relate to warning systems and methods, and more particularly to an out-of-network warning system and method for a mobile phone.

2. Description of Related Art

Mobile phones are often installed with a subscriber identification module (SIM) card, where each SIM card has a corresponding phone number. The phone number is provided by a corresponding telecommunication service provider. Different telecommunication service provider can provide a different range of many phone numbers. If a mobile phone makes a call with a dialed phone number of a different telecommunication service provider (e.g., an out-of-network service provider) than that of a phone number of the mobile phone, the cost of the call will be expensive.

However, it is difficult to know whether the dialed phone number is provided by a different telecommunication service provider than that of the phone number of the mobile phone.

### BRIEF DESCRIPTION OF THE DRAWINGS

FIG. 1 is a block diagram of one embodiment of an out-of-network warning system and method for a mobile phone.

FIG. 2 is a flowchart of one embodiment of an out-of-network warning system and method for a mobile phone.

### DETAILED DESCRIPTION

All of the processes described below may be embodied in, and fully automated via, functional code modules executed by one or more general purpose computers or processors. The code modules may be stored in any type of computer-readable medium or other storage device device. Some or all of the methods may alternatively be embodied in specialized computer hardware or communication apparatus.

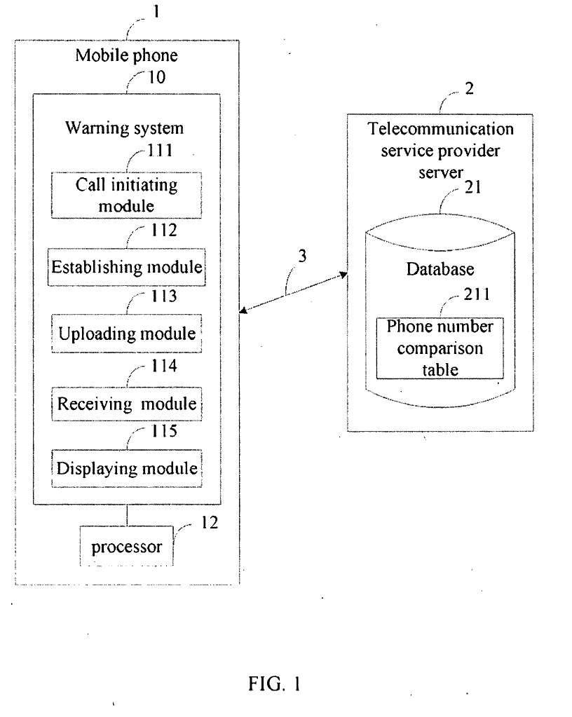

FIG. 1 is a block diagram of one embodiment of a warning system 10 for a mobile phone 1. The warning system 10 is implemented in the mobile phone 1, and configured for detecting whether a dialed phone number is from a different telecommunication service provider (hereinafter, “TSP”) than that of the phone number of the mobile phone 1. The warning system 10 is further configured for displaying a call type on the mobile phone 1 for further action. It may be understood that the different TSP is considered an out-of-network service provider.

The mobile phone 1 can communicate with a TSP server 2 via a communication network 3. The TSP server 2 includes a database 21. The database 21 includes a phone number comparison table 211. The phone number comparison table 211 is used for storing phone numbers registered by the TSP server 2. In one embodiment, the TSP server 2 may be China Unicom server, China Mobile server, China Telecom server, AT&T server or any other TSP server.

In one embodiment, the warning system 10 may include a call initialing module 111, an establishing module 112, an uploading module 113, a receiving module 114, and a displaying module 115. The modules 111, 112, 113, 114, and 115 may be used to perform one or more operations of the mobile phone 1. Depending on embodiment, the mobile phone 1 may include one or more specialized or general purpose processors, such as a processor 12 for executing at least one operation for the modules 111, 112, 113, 114, and 115.

The call initiating module 111 is configured for initiating a call from the mobile phone 10 using a dialed phone number.

The establishing module 112 is configured for establishing a communication network connection between the mobile phone 1 and the TSP server 2.

The uploading module 113 is configured for uploading the dialed phone number to the TSP server 2. The TSP server 2 determines if the dialed phone number is in the database 21 of the TSP server 2 and to get a call type based on the determination. If the dialed phone number is in the phone number comparison table 211, the call type indicates that the call is an intra-network mobile-to-mobile call. If the phone number is not in the phone number comparison table 211, the call type indicates the call is an out-of-network mobile-to-mobile call. In one example, the TSP server 2 determines if the phone number is in the database 21 based on a comparison of the dialed phone number with the phone numbers stored in the phone number comparison table 211 of the database 21.

The receiving module 114 is configured for receiving the call type from the TSP server 2.

The displaying module 115 is configured for displaying the call type on a display of the mobile phone 1 for further action. In one example, the call type may be displayed on the display of the mobile phone 1 in a form of a prompt. The prompt may include one or more user-selectable options to choose from. As an example, if the call type indicates the call is the out-of-network mobile-to-mobile call, the call can be ended or cut short to decrease the cost of the call.

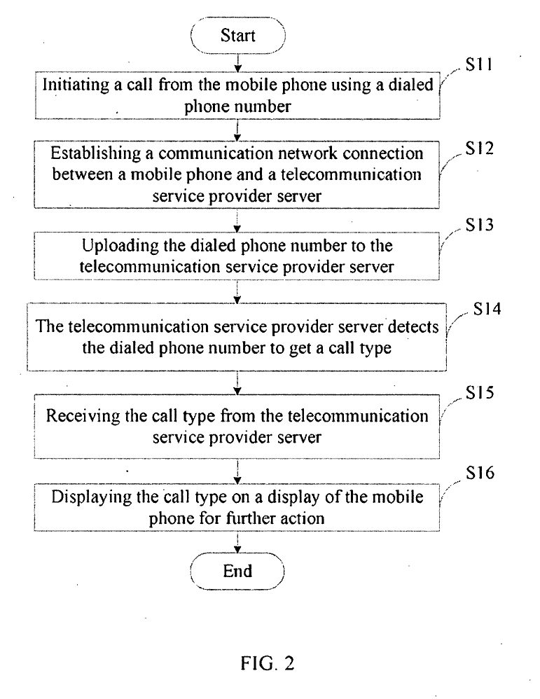

FIG. 2 is a flowchart of one embodiment of an out-of-network warning system and method for a mobile phone. Depending on the embodiment, additional blocks may be added, others removed, and the ordering of the blocks may be changed.

In block S11, the initialing module 111 initiates a call from the mobile phone 10 using a dialed phone number.

In block S12, the establishing module 112 establishes a communication network connection between the mobile phone 1 and the TSP server 2. In one embodiment, the TSP server 2 is a China Mobile server.

In block S13, the uploading module 113 uploads the dialed phone number to the TSP server 2.

In block S14, the TSP server 2 detects whether the dialed phone number is in the phone number comparison table 211 to get a call type, and sending the call type to the mobile phone 1. If the dialed phone number is in the phone number comparison table 211, the call type indicates that the call is an intra-network mobile-to-mobile call. If the phone number is not in the phone number comparison table 211, the call type indicates that the call is an out-of-network mobile-to-mobile call. For example, the dialed phone number may be provided by China Unicom.

In block S15, the receiving module 114 receives the call type from the TSP server 2.

In block S16, the displaying module 115 displays the call type on a display of the mobile phone 1 for further action. If the call type indicates the call is the out-of-network mobile-to-mobile call, the call can be ended or cut short to decrease the cost of the call.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An out-of-network warning system for a mobile phone, the system comprising:
a call initiating module configured for initiating a phone call using a dialed phone number;
an establishing module configured for establishing a communication network connection between the mobile phone and a telecommunication service provider server;
an uploading module configured for uploading the dialed phone number to the telecommunication service provider server, the telecommunication service provider server determining a call type according to the dialed phone number;
a receiving module configured for receiving the call type from the telecommunication service provider server;
a displaying module configured for displaying the call type on a display of the mobile phone for further action; and
at least one processor executing computerized operations for the dialing module, the establishing module, the uploading module, the receiving module, and the displaying module.

2. The system according to claim 1, wherein the telecommunication service provider server comprises a phone number comparison table.

3. The system according to claim 2, wherein the telecommunication service provider server determines the call type according to a comparison of the dialed phone number with phone numbers in the phone number comparison table.

4. The system according to claim 3, wherein, the call type indicates that the call is an intra-network mobile-to-mobile call if the dialed phone number is in the phone number comparison table, and wherein the call type indicates an out-of-network mobile-to-mobile call if the phone number is not in the phone number comparison table.

5. An out-of-network warning method for a mobile phone, the method comprising:
initiating a phone call using a dialed phone number;
establishing a communication network connection between the mobile phone and a telecommunication service provider server;
uploading the dialed phone number to the telecommunication service provider server, wherein the telecommunication service provider server determines a call type of the dialed phone number according to the dialed phone number;
receiving the call type from the telecommunication service provider server; and
displaying the call type on a display of the mobile phone for further action.

6. The method according to claim 5, wherein the telecommunication service provider server comprises a phone number comparison table.

7. The method according to claim 6, wherein the telecommunication service provider server determines the call type according to a comparison of the dialed phone number with phone numbers in the phone number comparison table.

8. The method according to claim 7, wherein, the call type indicates that the call is an intra-network mobile-to-mobile call if the dialed phone number is in the phone number comparison table, and wherein the call type indicates a out-of-network mobile-to-mobile call if the phone number is not in the phone number comparison table.

9. A storage medium having stored thereon instructions that, when executed by a processor, causing the processor to perform a warning method when a mobile phone is used to initiate a call, the method comprising:
initiating a phone call using a dialed phone number;
establishing a communication network connection between the mobile phone and a telecommunication service provider server;
uploading the dialed phone number to the telecommunication service provider server, wherein the telecommunication service provider server determines a call type of the dialed phone number according to the dialed phone number;
receiving the call type from the telecommunication service provider server; and
displaying the call type on a display of the mobile phone for further action.

10. The medium according to claim 9, wherein the telecommunication service provider server comprises a phone number comparison table.

11. The medium according to claim 10, wherein the telecommunication service provider server determines the call type according to a comparison of the dialed phone number with phone numbers in the phone number comparison table.

12. The medium according to claim 11, wherein, the call type indicates that the call is an intra-network mobile-to-mobile call if the dialed phone number is in the phone number comparison table, and wherein the call type indicates a out-of-network mobile-to-mobile call if the phone number is not in the phone number comparison table.
